(19) United States
(12) Patent Application Publication
(10) Pub. No.: US 2025/0262859 A1
(43) Pub. Date: Aug. 21, 2025

(54) LIQUID DISCHARGE APPARATUS AND MAINTENANCE METHOD

(71) Applicant: Yuki NAGATSUKA, KANAGAWA (JP)

(72) Inventor: Yuki NAGATSUKA, KANAGAWA (JP)

(21) Appl. No.: 19/023,322

(22) Filed: Jan. 16, 2025

(30) Foreign Application Priority Data
Feb. 20, 2024 (JP) 2024-023871

(51) Int. Cl. B41J 2/165; B41J 3/54

(52) U.S. Cl. CPC B41J 2/16517; B41J 3/543; B41J 2002/16573

(57) ABSTRACT

A liquid discharge apparatus includes a head, a maintenance mechanism, and circuitry. The head discharges a liquid. The maintenance mechanism maintains the head. The circuitry learns usage patterns of a user to use the liquid discharge apparatus, determines an expected usage start time of the liquid discharge apparatus based on the usage patterns, sets a maintenance start time to start maintaining the head shortly before the expected usage start time, and controls the maintenance mechanism to start maintaining the head at the maintenance start time and complete maintaining the head by the expected usage start time.

### CROSS-REFERENCE TO RELATED APPLICATION

This patent application is based on and claims priority pursuant to 35 U.S.C. § 119 (a) to Japanese Patent Application No. 2024-023871, filed on Feb. 20, 2024, in the Japan Patent Office, the entire disclosure of which is hereby incorporated by reference herein.

### BACKGROUND

### Technical Field

The present disclosure relates to a liquid discharge apparatus and a maintenance method.

### Related Art

In the related art, a liquid discharge apparatus (e.g., an inkjet printer) includes a liquid discharge head.

### SUMMARY

The present disclosure described herein provides an improved liquid discharge apparatus including a head, a maintenance mechanism, and circuitry. The head discharges a liquid. The maintenance mechanism maintains the head. The circuitry learns usage patterns of a user to use the liquid discharge apparatus, determines an expected usage start time of the liquid discharge apparatus based on the usage patterns, sets a maintenance start time to start maintaining the head shortly before the expected usage start time, and controls the maintenance mechanism to start maintaining the head at the maintenance start time and complete maintaining the head by the expected usage start time.

The present disclosure described herein further provides an improved maintenance method including maintaining a head of a liquid discharge apparatus, learning usage patterns of a user to use the liquid discharge apparatus, determining an expected usage start time of the liquid discharge apparatus based on the usage patterns, setting a maintenance start time to start maintaining the head shortly before the expected usage start time, and starting maintaining the head at the maintenance start time and completing maintaining the head by the expected usage start time.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1A is a schematic perspective view of a liquid discharge apparatus;

FIG. 1B is a schematic front view of the liquid discharge apparatus of FIG. 1A;

FIG. 1C is a schematic side view of the liquid discharge apparatus of FIG. 1A;

FIG. 2 is a schematic plan view of a liquid discharge apparatus;

FIG. 3 is a schematic plan view of heads;

FIGS. 4A to 4C are block diagrams of a controller of a liquid discharge apparatus;

FIGS. 5A and 5B are diagrams illustrating a usage status and a usage table created from the usage status, respectively;

FIGS. 6A to 6C are diagrams illustrating a usage table for one week, and usage tables by day of the week and by hour created from the usage table for one week, respectively;

FIG. 7 is a diagram illustrating an expected usage start time and a maintenance start time;

FIG. 8 is a temperature and humidity table indicating temperature and humidity coefficients determined from temperature and humidity;

FIGS. 9A to 9C are diagrams each illustrating a schedule of automatic maintenance; and

FIG. 10 is a schematic view of an electrode manufacturing apparatus.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

In a comparative liquid discharge apparatus (e.g., an inkjet printer) including a liquid discharge head, when ink having a rapid drying property or ink containing a sedimentation component is used, the ink may adhere to the inside of a nozzle during standby of the apparatus. As a result, the nozzle of the liquid discharge head may be clogged with the ink, and the ink may not be discharged from the nozzle.

A liquid discharge apparatus and a maintenance method according to embodiments of the present disclosure are described below with reference to the drawings. Embodiments of the present disclosure are not limited to the embodiments described below and may be other embodiments than the embodiments described below. The following embodiments may be modified by, for example, addition, modification, or omission within the scope that would be obvious to one skilled in the art. Any aspects having advantages as described for the following embodiments according to the present disclosure are included within the scope of the present disclosure.

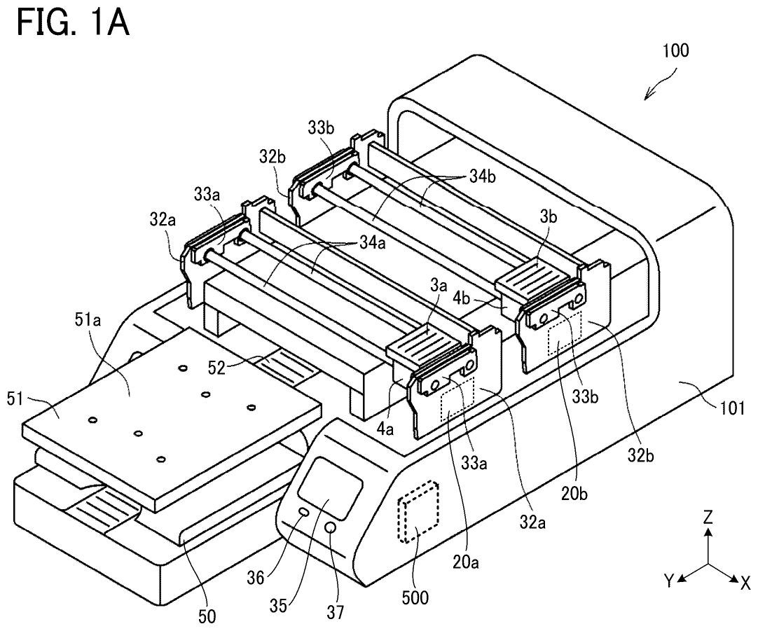

FIG. 1A is a schematic perspective view of a liquid discharge apparatus 100. FIG. 1B is a schematic front view of the liquid discharge apparatus 100 of FIG. 1A. FIG. 1C is a schematic side view of the liquid discharge apparatus 100 of FIG. 1A. The liquid discharge apparatus 100 illustrated in FIGS. 1A to 1C is a garment printer.

In FIGS. 1A and 1B, the X direction is the main scanning direction or the left-right direction of the liquid discharge apparatus 100. In FIGS. 1A and 1C, a cloth, which may be referred to as a print target or a liquid application target, is conveyed in the Y direction. The Y direction includes a forward conveyance direction of the cloth and a reverse conveyance direction opposite to the forward conveyance direction. In other words, the Y direction is the front-rear direction of the liquid discharge apparatus 100. In FIGS. 1A to 1C, the Z direction is the vertical direction of the liquid discharge apparatus 100. The X, Y, and Z directions are orthogonal to each other.

As illustrated in FIG. 1A, the liquid discharge apparatus 100 includes a first carriage 3a, a second carriage 3b, a pair of first side plates 32a, a pair of second side plates 32b, first adjustment plates 33a as a pair of holders, second adjustment plates 33b as a pair of holders, first guide rods 34a as a pair of guides, and second guide rods 34b as a pair of guides. In the following description, the first carriage 3a and the second carriage 3a are referred to as a carriage 3 unless otherwise distinguished, the first side plates 32a and the second side plates 32b are referred to as side plates 32 unless otherwise distinguished, the first adjustment plates 33a and the second adjustment plates 33b are referred to as adjustment plates 33 unless otherwise distinguished, and the first guide rods 34a and the second guide rods 34b are referred to as guide rods 34 unless otherwise distinguished.

The side plates 32 are disposed on both sides in the left-right direction of the liquid discharge apparatus 100 and are fixed to a body 101 of the liquid discharge apparatus 100. The side plates 32 movably hold the corresponding adjustment plates 33 in the Y direction and the Z direction. Both ends of the guide rod 34 are respectively held by the adjustment plates 33. Each adjustment plate 33 holds two guide rods 34 in the Y direction.

The carriage 3 is supported by the guide rods 34 so that the carriage 3 is movable along the guide rods 34. In other words, the carriage 3 moves in the X direction (an example of a first movement direction) orthogonal to a conveyance direction (the Y direction) of a cloth (an example of a print medium) as a print target or a liquid application target. The carriage 3 includes multiple heads 4 (heads 4a and 4b in FIG. 1A). The head 4 is an example of a liquid discharge head that discharges a liquid such as ink onto a cloth (an example of a print medium) as a print target or a liquid application target to form (print) an image (print image) on the cloth. The head 4 has a nozzle face on a lower face thereof.

The liquid discharge apparatus 100 includes a rail 52 extending in the Y direction on the body 101. A platen 51 holds a cloth as a print target or a liquid application target. Specifically, a cloth is placed on a placement face 51a of the platen 51. The placement face 51a may be referred to as a liquid application target placement face. The placement face 51a is orthogonal to the direction Z. However, the placement face 51a may not be strictly orthogonal to the direction Z.

The platen 51 is fixed to a stage 50 and moves downstream in the conveyance direction together with the stage 50 on the rail 52. At this time, the head 4 of the carriage 3 discharges ink as a liquid onto a cloth on the platen 51 while the carriage 3 reciprocally moves on the guide rods 34 in the main scanning direction (X direction). Thus, an image is formed on the cloth. The platen 51 can be moved in the Z direction relative to a base to adjust a height of the placement face 51a of the platen 51.

Since the liquid discharge apparatus 100 includes the multiple carriages 3 (i.e., the first carriage 3a and the second carriage 3b) and the multiple heads 4, inks of different colors can be discharged onto a cloth, and the print speed on the cloth can be increased. Accordingly, the productivity of the liquid discharge apparatus 100 can be increased.

A head tank that temporarily stores ink to be discharged is disposed directly above the head 4 in the carriage 3. The head tank is coupled to an ink cartridge 38 illustrated in FIG. 1C via an ink supply tube and an ink supply pump. The ink supply pump is operated to supply ink from the ink cartridge 38 to the head tank as desired. As illustrated in FIG. 1C, the liquid discharge apparatus 100 includes a cover 102 that is opened and closed, and the cover 102 has a vent hole 53.

The liquid discharge apparatus 100 includes a maintenance mechanism (maintenance unit) 20 (i.e., maintenance mechanisms 20a and 20b in FIG. 1A) on one end in the main scanning direction (X direction). The maintenance mechanism 20 maintains the head 4.

The liquid discharge apparatus 100 includes a discharge receptacle on the other end in the main scanning direction (X direction). The head 4 discharged a liquid to the discharge receptacle during printing to maintain and recover the head 4.

The maintenance mechanism 20 includes a cap that covers the nozzle face of the head 4 on which nozzles are arranged to protect an exposed portion of ink in the head 4 from drying when the liquid discharge apparatus 100 does not perform printing.

The cap includes two types: a moisture-retentive cap and a suction cap. The moisture-retentive cap has a function of protecting ink from drying. The suction cap is coupled to a suction pump and sucks thickened ink from the head 4. Thus, the suction cap has a function of recovering the head 4 to an appropriate state in addition to the function of the moisture-retentive cap.

The maintenance mechanism 20 further includes a wiper that removes excessive ink remaining on the nozzle face after sucking ink to recover the nozzle state of the head 4. After the viscous ink in the head 4 is sucked, the wiper wipes the nozzle face to scrap off the excessive ink and make the meniscus in the nozzle in a normal state.

A controller 500 as circuitry is incorporated in the body 101, and the liquid discharge apparatus 100 is operated under the control of each unit of the controller 500. A control panel 35, an external connection terminal 36, and a power button 37 are disposed on the front face of the body 101.

The control panel 35 includes an operation unit for inputting various settings and a display unit for displaying information. The operation unit and the display unit may be separately disposed on the front face. Alternatively, the operation unit such as a pressure-sensitive or electrostatic-capacitive transparent film switch is overlaid on the display unit such as a liquid crystal display to form a touch panel.

The external connection terminal 36 is, for example, a universal serial bus (USB) terminal. The liquid discharge apparatus 100 can be communicably connected to an information processing apparatus such as a digital camera, a smartphone, or a personal computer (PC) via the external connection terminal 36. The communication with the information processing apparatus is not limited to the USB terminal, and may be a terminal of another standard. The communication with the information processing apparatus is not limited to wired communication, and the liquid discharge apparatus 100 may receive image data from the information processing apparatus by wireless communication.

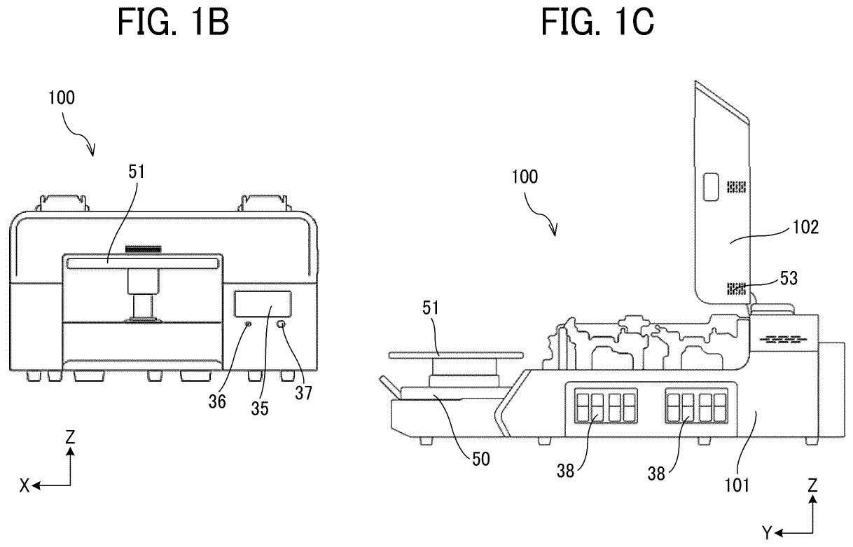

FIG. 2 is a schematic plan view of a mechanical section of a liquid discharge apparatus 100. The liquid discharge apparatus 100 illustrated in FIG. 2 is a serial type inkjet printer.

The liquid discharge apparatus 100 includes a carriage 3, a main guide 2, and a sub-guide. The main guide 2 is bridged between left and right side plates, and the main guide 2 and the sub guide movably hold the carriage 3. The carriage 3 is reciprocally moved in the main scanning direction by a main scanning motor 5 via a timing belt 8 looped around a drive pulley 6 and a driven pulley 7.

Heads 4a and 4b (may be referred to as the “head 4” unless distinguished) as liquid discharge heads are mounted on the carriage 3. The head 4 discharges liquid droplets (ink droplets) of colors of, for example, yellow (Y), cyan (C), magenta (M), and black (K). In the head 4, multiple nozzle rows are arranged in the main scanning direction, and multiple nozzles are arrayed in the sub-scanning direction orthogonal to the main scanning direction in each of the multiple nozzle rows. Each nozzle is directed downward so that the liquid droplets as liquid are discharged downward.

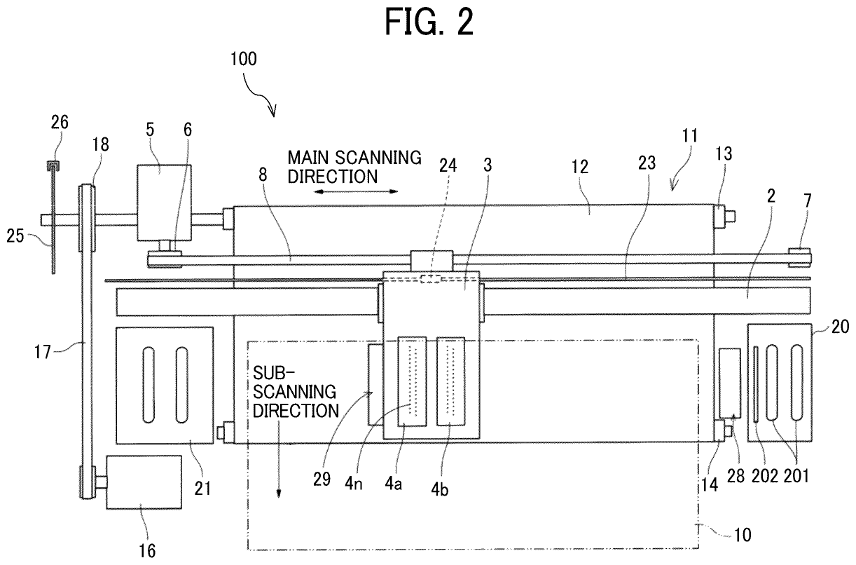

FIG. 3 is a schematic plan view of the heads 4a and 4b. The heads 4a and 4b may be referred to as the head 4 unless otherwise distinguished.

For example, as illustrated in FIG. 3, each of the heads 4a and 4b includes two nozzle rows Na and Nb in each of which multiple nozzles 4n are arranged in a line. The nozzle row Na of the head 4a discharges liquid droplets of black (K), and the nozzle row Nb of the head 4a discharges liquid droplets of cyan (C). The nozzle row Na of the head 4b discharges liquid droplets of magenta (M), and the nozzle row Nb of the head 4b discharges liquid droplets of yellow (Y).

The head 4 as the liquid discharge head can employ, for example, a piezoelectric actuator such as a piezoelectric element, or a thermal actuator using a phase change due to film boiling of liquid using an electrothermal transducer such as a thermal resistor.

The liquid discharge apparatus 100 includes a conveyance mechanism 11 including a conveyance belt 12 as a conveyor. The conveyance mechanism 11 conveys a sheet 10 such as paper so that the sheet 10 faces the head 4. The sheet 10 is an example of a print medium and may be referred to as a print target or a liquid application target. The conveyance belt 12 is an endless belt looped around a conveyance roller 13 and a tension roller 14.

The conveyance belt 12 circumferentially moves (rotates) in the sub-scanning direction as the conveyance roller 13 is rotationally driven by a sub-scanning motor 16 via a timing belt 17 and a timing pulley 18. The conveyance belt 12 is charged (given a charge) by a charging roller while rotating.

On one end of the range of movement of the carriage 3 in the main scanning direction, a maintenance mechanism 20 that maintains and recovers the head 4 is disposed lateral to the conveyance belt 12. On the other end of the range of movement of the carriage 3 in the main scanning direction, a discharge receptacle 21 that receives liquid droplets discharges from the head 4 is disposed lateral to the conveyance belt 12.

The maintenance mechanism 20 includes, for example, a cap 201 to cap the nozzle face (i.e., the surface on which the nozzles are formed) of the head 4 and a wiper 202 to wipe the nozzle face. The maintenance mechanism 20 may further include a discharge receptacle that receives liquid not contributing to image formation. The wiper 202 is, for example, a web wiping device so as not to damage the nozzle face even when the wiper 202 cleans the nozzle face that is not wet with ink.

A discharge detection unit 28 constructing a discharge detector detects whether or not liquid droplets are discharged. The discharge detection unit 28 may be disposed in a region outside a recording region and between the conveyance mechanism 11 and the maintenance mechanism 20. The discharge detection unit 28 in the region can face the head 4. The carriage 3 may be provided with a wiping unit 29 that cleans an electrode of the discharge detection unit 28.

An encoder scale 23 having a predetermined pattern extends in the main scanning direction of the carriage 3 between the side plates. The carriage 3 includes a main scanning encoder sensor 24 including a transmissive photosensor that reads the predetermined pattern on the encoder scale 23. The encoder scale 23 and the main scanning encoder sensor 24 construct a linear encoder (i.e., a main scanning encoder) that detects the movement of the carriage 3.

A code wheel 25 is mounted on a shaft of the conveyance roller 13. A sub-scanning encoder sensor 26 including a transmissive photosensor detects a pattern formed on the code wheel 25. The code wheel 25 and the sub-scanning encoder sensor 26 construct a rotary encoder (i.e., a sub-scanning encoder) that detects the amount of movement and the position of movement of the conveyance belt 12.

In the liquid discharge apparatus 100 (inkjet printer) illustrated in FIG. 2, the sheet 10 fed from a sheet feeding tray is attracted to the charged conveyance belt 12 and conveyed in the sub-scanning direction by the circumferential movement of the conveyance belt 12. The carriage 3 moves in the main scanning direction and drives the head 4 in accordance with an image signal. Thus, ink droplets are discharged onto the sheet 10 that has been conveyed and stopped to record, for example, one line of an image. Subsequently, the sheet 10 is conveyed by a predetermined amount in the sub-scanning direction, and then the next line of the image is recorded. By repeating such an operation, an image is printed on the sheet 10 line by line. The sheet 10 on which printing has been performed is ejected to a sheet ejection tray.

In the above embodiments, the cloth and the sheet are exemplified as the print target or the liquid application target, but the print target or the liquid application target is not limited thereto, and the print target or the liquid application target may be any medium onto which liquid can adhere.

The above-described term “medium onto which liquid can adhere” represents a medium on which liquid is at least temporarily adhered, a medium on which liquid is adhered and fixed, or a medium into which liquid adheres and permeates. Specific examples of the “medium onto which liquid can adhere” include, but are not limited to, a recording medium such as a paper sheet, recording paper, a recording sheet of paper, a film, or cloth, an electronic component such as an electronic substrate or a piezoelectric element, and a medium such as layered powder, an organ model, or a testing cell. The “medium onto which liquid can adhere” includes any medium to which liquid adheres, unless otherwise specified.

Examples of materials for the “medium onto which liquid can adhere” include any materials to which liquid can adhere even temporarily, such as paper, thread, fiber, fabric, leather, metal, plastic, glass, wood, and ceramic.

The term “liquid discharge apparatus” used herein includes, in addition to apparatuses to discharge liquid to a medium onto which liquid can adhere, apparatuses to discharge the liquid into gas (air) or a different liquid.

The “liquid discharge apparatus” may further include devices relating to feeding, conveying, and ejecting of the medium onto which liquid can adhere and also include a pretreatment device and an aftertreatment device.

The “liquid discharge apparatus” may be, for example, an image forming apparatus to form an image on a sheet by discharging ink, or a three-dimensional fabrication apparatus to discharge fabrication liquid to a powder layer in which powder material is formed in layers to form a three-dimensional object.

The “liquid discharge apparatus” is not limited to an apparatus that discharges liquid to visualize meaningful images such as letters or figures. For example, the liquid discharge apparatus may be an apparatus that forms patterns having no meaning or an apparatus that fabricates three-dimensional images.

### Electrode Manufacturing Apparatus

The liquid discharge apparatus according to an embodiment of the present disclosure may also include an apparatus for manufacturing an electrode and an electrochemical element that is also referred to as an electrode manufacturing apparatus. The electrode manufacturing apparatus is described below.

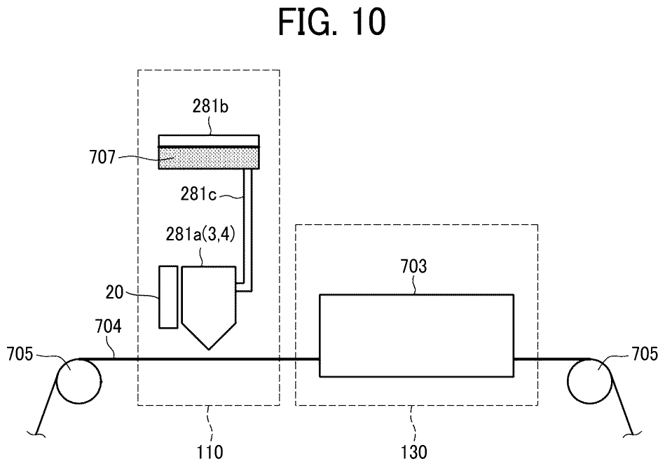

FIG. 10 is a schematic view of the electrode manufacturing apparatus as a liquid discharge apparatus. The electrode manufacturing apparatus is an apparatus for manufacturing an electrode including a layer containing an electrode material by discharging a liquid composition using a head module 281a including the head 4 as a liquid discharge head. The electrode manufacturing apparatus includes the carriage 3 on which the head 4 is mounted and the maintenance mechanism 20 that maintains the head 4.

### Device for Forming Layer Containing Electrode Material and Process of Forming Layer Containing Electrode Material

As a discharge device of the electrode manufacturing apparatus illustrated in FIG. 10, the head 4 of the head module 281a discharges a liquid composition. By so doing, the liquid composition is applied onto an object, and a liquid composition layer is formed on the object. The object, which may also be referred to as a discharge target in the following description, is not limited to any particular object and may be appropriately selected depending on the intended purpose, as long as the object is an object on which a layer containing an electrode material is to be formed. Examples of the object include an electrode substrate, i.e., a current collector, an active material layer, and a layer containing a solid electrode material. The object may be an electrode composite layer containing an active material on an electrode substrate, i.e., a current collector. The discharge device and a discharge process may be a device and a process of forming a layer containing an electrode material by directly discharging a liquid composition as long as the layer containing an electrode material can be formed on a discharge target. The discharge device and the discharge process may be a device and a process of forming a layer containing an electrode material by indirectly discharging a liquid composition.

### Other Devices and Other Processes

Other configurations included in the electrode manufacturing apparatus for manufacturing an electrode composite layer are not limited to any particular configuration and may be appropriately selected depending on the intended purpose, as long as the effects of the present embodiment are not impaired. Other processes included in the method for manufacturing an electrode composite layer are not limited to any particular process and may be appropriately selected depending on the intended purpose, as long as the effects of the present embodiment are not impaired. For example, a heating device and a heating process are examples of the configuration and the process included in the electrode manufacturing apparatus and the manufacturing method of the electrode composite layer.

### Heating Device and Heating Process

The heating device included the electrode manufacturing apparatus for manufacturing an electrode composite layer is a device that heats the liquid composition discharged by the discharge device. The heating process included in the manufacturing method for manufacturing an electrode composite layer is a process of heating the liquid composition discharged in the discharge process. The liquid composition is heated to dry the liquid composition layer.

### Structure to Form Layer Containing Electrode Material by Direct Discharge of Liquid Composition

As an example of the electrode manufacturing apparatus, an electrode manufacturing apparatus that forms an electrode composite layer containing an active material on an electrode substrate, i.e., a current collector, is described below. As illustrated in FIG. 10, the electrode manufacturing apparatus includes a discharge process device 110 and a heating process device 130. The discharge process device 110 performs a discharge process of applying a liquid composition onto a print base material 704 having a discharge target to form a liquid composition layer. The heating process device 130 performs a heating process of heating the liquid composition layer to obtain an electrode composite layer.

The electrode manufacturing apparatus includes a conveyor 705 that conveys the print base material 704. The conveyor 705 conveys the print base material 704 to the discharge process device 110 and the heating process device 130 in this order at a preset speed. A method of producing the print base material 704 having the discharge target such as an active material layer is not limited to any particular method, and a known method can be appropriately selected. The discharge process device 110 includes the head module 281a that performs an application process of applying a liquid composition 707 onto the print base material 704, a storage container 281b that stores the liquid composition 707, and a supply tube 281c that supplies the liquid composition 707 stored in the storage container 281b to the head 4 of the head module 281a.

The discharge process device 110 discharges the liquid composition 707 from the head 4 of the head module 281a so that the liquid composition 707 is applied onto the print base material 704 to form a liquid composition layer in a thin film shape. The storage container 281b may be integrated with the electrode manufacturing apparatus that forms the electrode composite layer or may be detachable from the electrode manufacturing apparatus. The storage container 281b may be a container additionally attachable to a container integrated with the electrode manufacturing apparatus for manufacturing the electrode composite layer or to a container detachable from the electrode manufacturing apparatus for manufacturing the electrode composite layer. The storage container 281b that stably stores the liquid composition 707 and the supply tube 281c that stably supplies the liquid composition 707 can be used.

The heating process device 130 performs a solvent removing process of heating and removing the solvent remaining in the liquid composition layer. Specifically, the solvent that remains in the liquid composition layer is heated and dried by a heater 703 of the heating process device 130. Accordingly, the solvent is removed from the liquid composition layer. Thus, the electrode composite layer is formed. The heating process device 130 may perform the solvent removing process under reduced pressure.

The heating device (i.e., the heater 703) is not limited to any particular heater and may be appropriately selected depending on the intended purpose. For example, the heater 703 may be a substrate heater, an infrared (IR) heater, or a hot air heater. The heater 703 may be a combination of at least two of the substrate heater, the IR heater, and the hot air heater. A heating temperature and heating time can be appropriately selected according to the boiling point of the solvent contained in the liquid composition 707 or the thickness of a formed film.

The electrode manufacturing apparatus according to the present embodiment is used to discharge the liquid composition to a desired position on the discharge target. The electrode composite layer can be suitably used, for example, as a part of the configuration of an electrochemical element. The configuration of the electrochemical element other than the electrode composite layer is not limited to any particular configuration, and a known configuration can be appropriately selected. Examples of the configuration other than the electrode composite layer include a positive electrode, a negative electrode, and a separator.

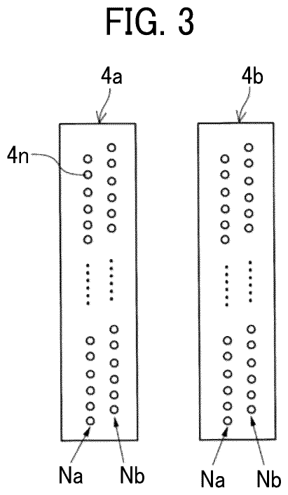

The controller 500 of the liquid discharge apparatus 100 will be described below with reference to FIGS. 4A to 4C. FIG. 4A is a block diagram of the entire controller 500, FIG. 4B is a diagram of a read-only memory (ROM) 502, and FIG. 4C is a block diagram illustrating functions implemented by executing a program stored in the ROM 502.

The controller 500 includes a main controller 500A including a central processing unit (CPU) 501, the ROM 502, a random-access memory (RAM) 503, and a nonvolatile random-access memory (NVRAM) 504. The CPU 501 controls the entire system of the liquid discharge apparatus 100. The ROM 502 stores programs executed by the CPU 501 and other fixed data. The RAM 503 temporarily stores, for example, image data. The NVRAM 504 stores various kinds of data such as a program and retains various kinds of data even while the power of the liquid discharge apparatus 100 is shut off.

The controller 500 further includes a host interface (I/F) 506 that controls data transmission with a host apparatus (information processor) 600, a print controller 511 that controls driving of the head 4, and an encoder analyzer 515. The encoder analyzer 515 receives and analyzes detection signals from the main scanning encoder sensor 24 and the sub-scanning encoder sensor 26. The controller 500 further includes an input/output (I/O) unit 507 between a main scanning driver 512 and a sub-scanning driver 513 that drives the sub-scanning motor 16, and various sensors and actuators 517.

The print controller 511 generates print data, generates a drive waveform for controlling the driving of the head 4, and transfers a head control signal for selecting a desired drive signal from the drive waveform and the print data to a head driver 510. The head driver 510 drives the head 4 based on the print data. Thus, the liquid corresponding to the print data is discharged from the nozzles of the head 4.

The controller 500 controls the driving of the main scanning motor 5 via the main scanning driver 512 based on the analysis result from the encoder analyzer 515 to control the movement of the carriage 3. The controller 500 controls the driving of the sub-scanning motor 16 via the sub-scanning driver 513 to control the feeding of the print target or the liquid application target. The sub-scanning driver 513 controls the movement of the stage 50 in the liquid discharge apparatus 100 of FIGS. 1A to 1C, and controls the movement of the conveyance belt 12 in the liquid discharge apparatus 100 of FIG. 2.

The controller 500 further includes a maintenance controller 518 that controls the maintenance mechanism 20 that maintains the head 4. The controller 500 further includes a timer 508 that counts, for example, a print execution time of the liquid discharge apparatus 100, a liquid discharge time from the head 4, and a maintenance time by the maintenance mechanism 20.

As illustrated in FIG. 4B, the ROM 502 stores a maintenance program 701 for performing the maintenance method according to the present embodiment. The ROM 502 further stores a temperature and humidity coefficient 702 to be referred to when the controller 500 determines the frequency of maintenance. The temperature and humidity coefficient will be described later. By executing the maintenance program 701, the controller 500 functions as a usage status learning unit 802 and a maintenance timing management unit 804 illustrated in FIG. 4C.

The liquid discharge apparatus 100 includes the head 4 to discharge a liquid, the maintenance mechanism 20 to maintain the head 4, the maintenance timing management unit 804 to manage (control) a timing of a maintenance of the head 4, and the usage status learning unit 802 to learn a usage status of the liquid discharge apparatus 100 by a user (i.e., usage patterns of a user to use the liquid discharge apparatus). The maintenance timing management unit 804 determines an expected usage start time T2 of the liquid discharge apparatus 100 by the user based on the usage status of the liquid discharge apparatus 100 learned by the usage status learning unit 802, sets a maintenance start time T1 so that a maintenance is performed immediately before the expected usage start time T2, and performs the maintenance by the maintenance mechanism 20 at the set maintenance start time T1.

The term “immediately before the expected usage start time” means that the time going back from the expected usage start time is short. An example of “immediately before the expected usage start time” is several minutes to several tens of minutes before the expected usage start time.

The phrase “maintenance is performed immediately before the expected usage start time” preferably means that the maintenance is performed immediately or shortly before the expected usage start time and the maintenance is completed by the expected usage start time.

For example, the maintenance is preferably completed about 10 minutes before the expected usage start time. In other words, the elapsed time from the completion of the latest maintenance to the expected usage start time is preferably about 10 minutes.

When the time from the maintenance to the start of usage of the apparatus (the start of printing) is long, a discharge failure may occur due to the influence of drying or sedimentation of ink. As a result, a desired printing quality may not be obtained at the start of printing. In contrast, the liquid discharge apparatus according to the present embodiment learns the time at which the user starts to use the liquid discharge apparatus on a daily basis, and optimizes the schedule of the maintenance based on the learned data. As a result, the maintenance is performed immediately before the user starts the printing.

The maintenance timing management unit 804 makes (plans) a schedule of automatic maintenance (maintenance schedule) for the head 4 in the liquid discharge apparatus 100 during standby (i.e., in standby mode) based on the usage status of the liquid discharge apparatus 100 learned by the usage status learning unit 802, and performs maintenance by the maintenance mechanism 20 based on the schedule.

For example, when the user starts printing at 10:00 am and ends printing at 5:00 pm every day, the maintenance timing management unit 804 optimizes the schedule of maintenance performed within 17 hours during standby from the end of printing on the previous day to the start of printing on the next day.

Examples of the optimization include completing maintenance immediately before the start of printing and minimizing (reducing) the number of times of maintenance. This optimization does not generate user's waiting (wasted) time and can reduce the amount of ink discarded in association with the maintenance.

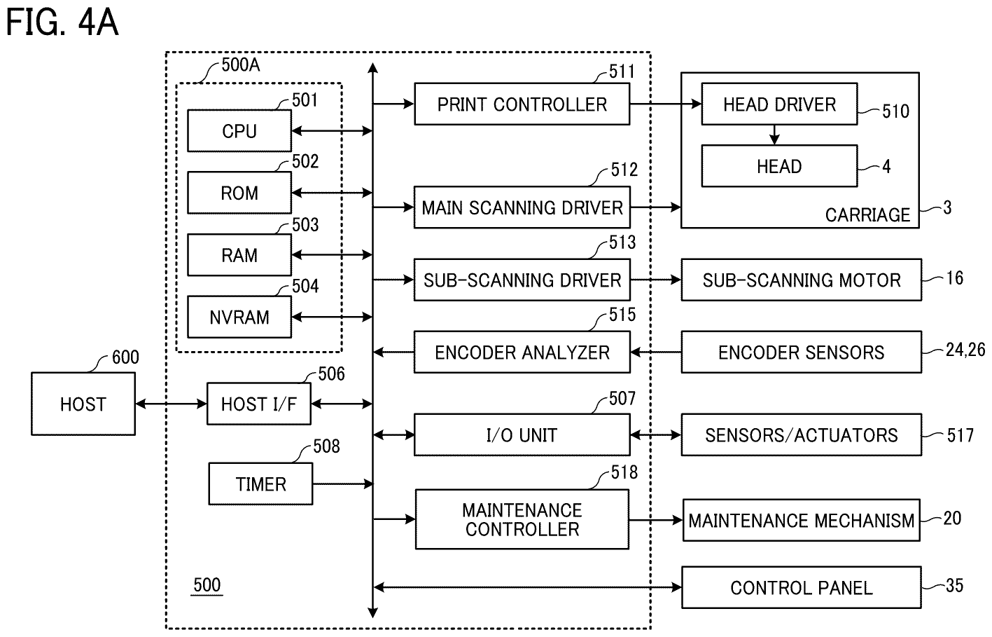

FIGS. 5A and 5B are diagrams illustrating a usage status of the liquid discharge apparatus 100 and a usage table created by the usage status learning unit 802 that learns the usage status, respectively. FIG. 5A illustrates a usage status 71 indicating the usage time of the liquid discharge apparatus 100 in one day. FIG. 5B illustrates a usage table 72 converted from the usage status 71. In the usage table 72, “1” represents “in use” and “0” represents “standby” in one hour increment.

The usage status learning unit 802 determines a status of the liquid discharge apparatus 100 when printing is performed and an operation is performed on the liquid discharge apparatus 100 as “in use,” determines the status when an operation is not performed on the liquid discharge apparatus 100 as “standby,” and learns the status.

The usage table 72 of FIG. 5B illustrates an example of a usage table in one hour increment, but the increment of the usage table is not limited thereto. The usage status can be grasped in more detail by a usage table in one minute increment or in one second increment.

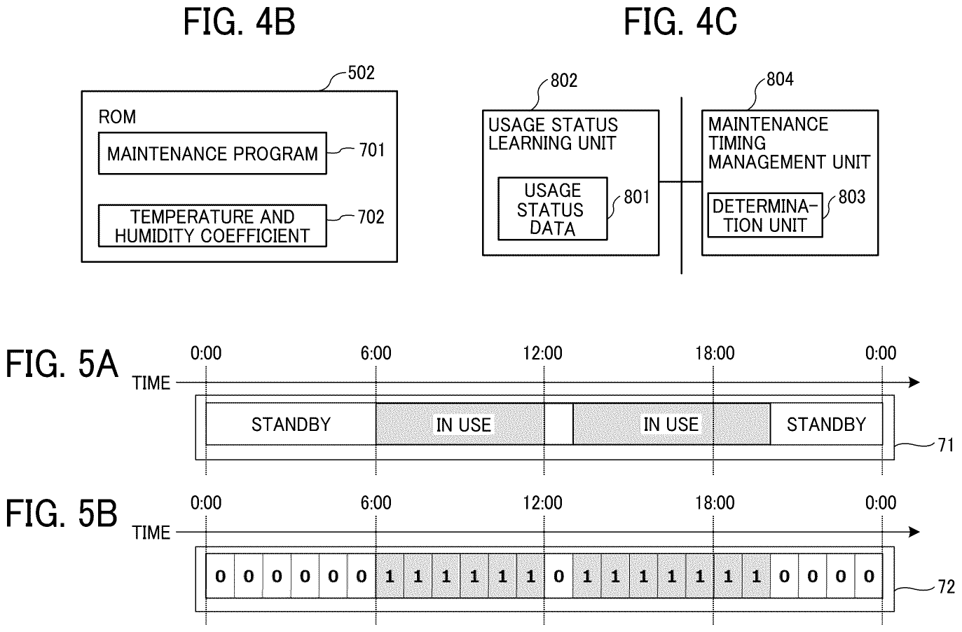

FIGS. 6A to 6C are diagrams illustrating a usage table for one week, and usage tables by day of the week and by hour created by the usage status learning unit 802 that learns the usage status from the usage table for one week, respectively.

FIG. 6A illustrates a usage table for one week 73. FIG. 6B illustrates a usage table by day of the week 74 derived from the usage table for one week 73. In the usage table by day of the week 74, “1” represents the used days on which the liquid discharge apparatus 100 is used and “0” represents the days on which the liquid discharge apparatus 100 is not used.

FIG. 6C illustrates a usage table by hour 75 derived from the usage table for one week 73. In the usage table by hour 75, “1” represents the used hours on which the liquid discharge apparatus 100 is used and “0” represents the hours on which the liquid discharge apparatus 100 is not used on weekdays (i.e., from Monday to Friday).

The usage status learning unit 802 can also determine that a day of the week on which the liquid discharge apparatus 100 is not used throughout the day is a holiday and exclude the day from the usage table. The usage status learning unit 802 can also determine that a day on which the liquid discharge apparatus 100 is used is a business day and learn the usage status on the business day to create a usage table (e.g., the usage table by hour 75). The increment of the usage table is not limited to one hour, and the usage status can be grasped in detail by the usage table in one minute increment or in one second increment.

Thus, the usage status learning unit 802 learns the days of the week and the hours when the user uses the liquid discharge apparatus 100, and stores the learned days and hours in the usage table as usage status data 801. The maintenance timing management unit 804 includes a determination unit 803 that determines the expected usage start time based on the usage status (i.e., the usage status data 801) of the liquid discharge apparatus 100 learned by the usage status learning unit 802.

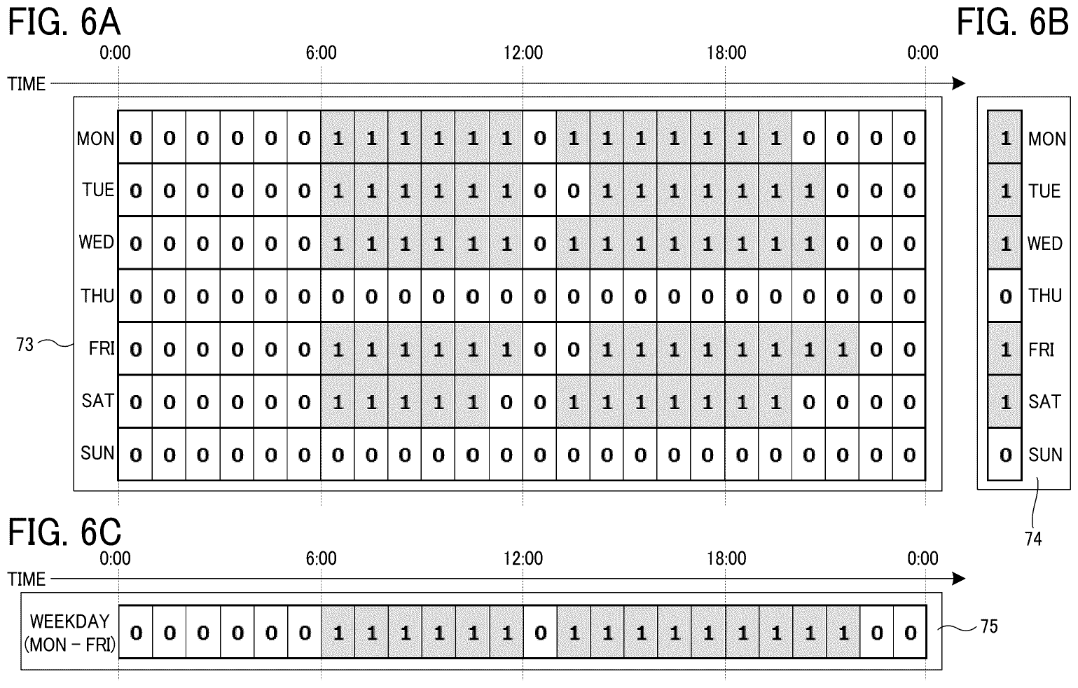

FIG. 7 is a diagram illustrating an expected usage start time and a maintenance start time. The maintenance timing management unit 804 sets the maintenance start time T1 so that the maintenance is performed immediately before the expected usage start time T2. The maintenance start time T1 is basically set in consideration of a maintenance time Ta when the maintenance is performed on the head 4, but is preferably set in consideration of the maintenance time Ta and a margin time Tb as illustrated in FIG. 7.

For example, based on the usage status learned by the usage status learning unit 802, when the usage start time of each day by the user varies widely, or when the length of the maintenance time varies widely due to the status or the environment of the head 4, the margin time Tb is preferably provided. As a result, the maintenance is completed immediately before the expected usage start time T2 without waiting (wasted) time, and a desired print quality is obtained at the start of printing.

In the liquid discharge apparatus 100, the frequency of automatic maintenance is preferably determined according to at least one of a drying speed, a sedimentation speed, or a discharge amount of the liquid discharged by the head 4 or a temperature and humidity coefficient based on the temperature and humidity around the head 4.

The maintenance timing management unit 804 can optimize the schedule of the automatic maintenance of the head 4 in the liquid discharge apparatus 100 during standby according to the usage status of the liquid discharge apparatus 100 learned by the usage status learning unit 802, at least one of the drying speed, the sedimentation speed, or the discharge amount of the liquid discharged by the head 4 or the temperature and humidity coefficient based on the temperature and humidity around the head 4.

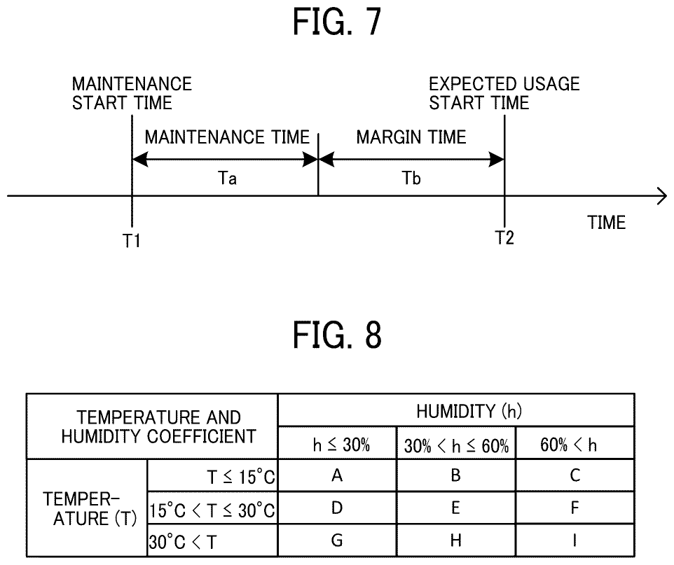

FIG. 8 illustrates a temperature and humidity table indicating temperature and humidity coefficients determined from the temperature and humidity around the head 4. The temperature and humidity coefficient is determined based on the temperature and humidity around the head 4 detected by the sensor, as illustrated in the temperature and humidity table of FIG. 8.

For example, since ink is more likely to dry at lower humidity, the temperature and humidity coefficient at a temperature equal to or less than 15° C. increases with a decrease in humidity (i.e., A>B>C in FIG. 8). The frequency of automatic maintenance determined using the temperature and humidity coefficient A is higher than the frequency of automatic maintenance determined using the temperature and humidity coefficient C.

The frequency of automatic maintenance can be determined, for example, using the following formula.

(maintenance frequency)=(reference frequency)×(coefficient)

The “reference frequency” is a frequency obtained from a basic maintenance interval set in advance based on, for example, the drying speed or the sedimentation speed of the ink discharged from the head 4, or the performance of the head 4 or the maintenance mechanism 20.

The temperature and humidity coefficient described above can be used as the “coefficient,” but the “coefficient” is not limited thereto. For example, any coefficient set according to the discharge amount of ink before the maintenance is performed or the status of the liquid discharge apparatus 100 can be used. When the coefficient is large, the frequency of maintenance is high, and when the coefficient is small, the frequency of maintenance is low.

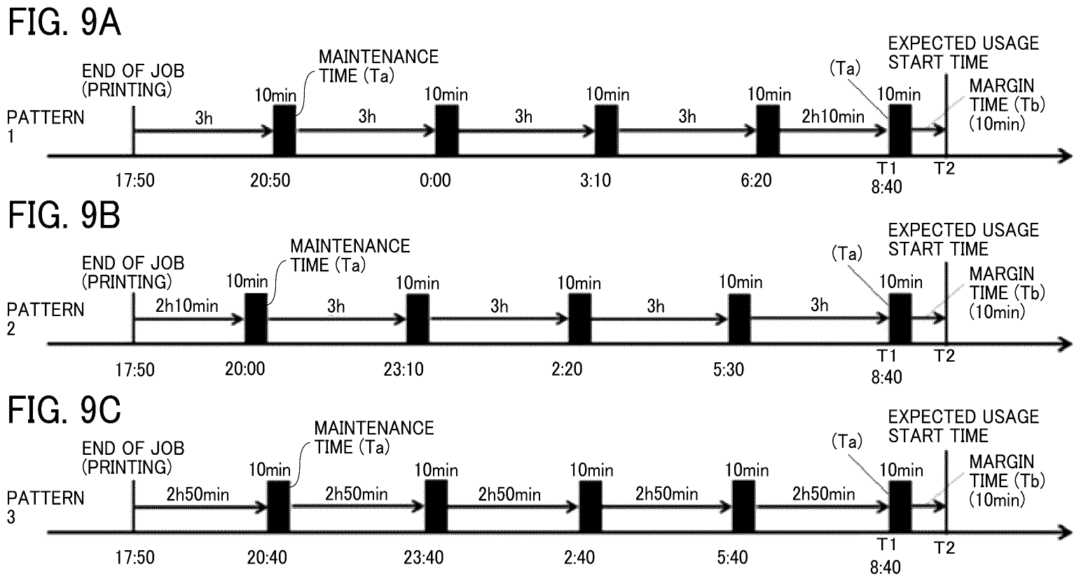

FIGS. 9A to 9C are diagrams each illustrating a schedule of automatic maintenance. The schedule of automatic maintenance is set based on the timing of maintenance performed immediately before the expected usage start time T2 and the maintenance frequency determined by the above formula. The schedule is set every time after the end of printing.

FIGS. 9A to 9C illustrate examples of the schedule of automatic maintenance set under the following conditions when the printing is ended at 17:50 and the expected usage start time T2 is determined to be 9:00 on the next day.

### Conditions

Maintenance time Ta: 10 minutes
Margin time Tb: 10 minutes
Maintenance frequency: 5 times

From the above conditions, the maintenance start time T1 immediately before the expected usage start time T2 is set to a time in consideration of the total of 20 minutes of the maintenance time Ta and the margin time Tb, i.e., 8:40 on the next day. The maintenance performed immediately before the expected usage start time T2 corresponds to the fifth maintenance.

For example, in Pattern 1 illustrated in FIG. 9A, the maintenance is repeatedly performed at a constant interval after the end of printing, and then the timing of maintenance performed immediately before the expected usage start time T2 is adjusted. In the schedule, four maintenances are performed at constant intervals of 3 hours, and then the fifth maintenance is performed at a shortened interval of 2 hours and 10 minutes.

In Pattern 2 illustrated in FIG. 9B, the timing of the first automatic maintenance is adjusted. The first maintenance is performed 2 hours and 10 minutes after the end of printing, and then the subsequent maintenances are performed at constant intervals of 3 hours.

In Pattern 3 illustrated in FIG. 9C, the intervals between maintenances are adjusted to be constant. The first to fifth maintenances are scheduled to be performed at constant intervals of 2 hours and 50 minutes.

As illustrated in the multiple patterns illustrated in FIGS. 9A to 9C, the schedule of automatic maintenance can be selected and set as appropriate as long as the maintenance is performed and completed immediately before the expected usage start time T2.

When the liquid discharge apparatus 100 includes multiple heads 4, the timing of maintenance can be determined for each of the multiple heads 4. In addition, when the liquid discharge apparatus 100 includes multiple heads 4, the timing of maintenance for the multiple heads 4 can be determined for the type of liquid discharged by each of the multiple heads 4.

A maintenance method of the liquid discharge apparatus according to the present embodiment includes a step in which the usage status learning unit 802 learns the usage status of the liquid discharge apparatus 100 by the user, a step in which the maintenance timing management unit 804 determines the expected usage start time T2 of the liquid discharge apparatus 100 by the user based on the usage status of the liquid discharge apparatus 100 learned by the usage status learning unit 802, a step in which the maintenance timing management unit 804 sets the maintenance start time T1 so that maintenance is performed immediately before the expected usage start time T2, and a step in which the maintenance mechanism 20 performs maintenance of the head 4 at the set maintenance start time T1.

The maintenance method of the present embodiment further includes a step in which the maintenance timing management unit 804 sets a schedule of automatic maintenance for the head 4 in the liquid discharge apparatus 100 during standby based on the usage status of the liquid discharge apparatus 100 learned by the usage status learning unit 802.

In the maintenance method of the present embodiment, the maintenance timing management unit 804 optimizes the schedule of the automatic maintenance for the head 4 in the liquid discharge apparatus 100 during standby using the usage status of the liquid discharge apparatus 100 learned by the usage status learning unit 802, at least one of the drying speed, the sedimentation speed, or the discharge amount of liquid discharged by the head 4 or the temperature and humidity coefficient set based on the temperature and humidity of a head environment.

According to the maintenance method of the present embodiment, the timing of maintenance can be optimized based on the usage status of the liquid discharge apparatus 100. As a result, a desired printing quality can be obtained from the start of printing. Further, the user's waiting (wasted) time is not generated. Furthermore, the amount of liquid (ink) discarded due to maintenance can be reduced.

Aspects of the present disclosure are, for example, as follows.

### Aspect 1

A liquid discharge apparatus includes a head to discharge a liquid, a maintenance-and-recovery mechanism to maintain the head, a maintenance timing management unit to manage a timing of a maintenance of the head, and a usage status learning unit to learn a usage status of the liquid discharge apparatus by a user. The maintenance timing management unit determines an expected usage start time of the liquid discharge apparatus by the user based on the usage status of the liquid discharge apparatus learned by the usage status learning unit, sets a maintenance start time so that the maintenance is performed immediately before the expected usage start time, and performs the maintenance by the maintenance-and-recovery mechanism at the set maintenance start time.

In other words, a liquid discharge apparatus includes a head, a maintenance mechanism, and circuitry. The head discharges a liquid. The maintenance mechanism maintains the head. The circuitry learns usage patterns of the user to use the liquid discharge apparatus, determines an expected usage start time of the liquid discharge apparatus based on the usage patterns, sets a maintenance start time to start maintaining the head shortly before the expected usage start time, and controls the maintenance mechanism to start maintaining the head at the maintenance start time and complete maintaining the head by the expected usage start time.

### Aspect 2

In the liquid discharge apparatus according to Aspect 1, the maintenance timing management unit sets a schedule of automatic maintenance for the head in the liquid discharge apparatus during standby based on the usage status of the liquid discharge apparatus learned by the usage status learning unit, and performs the maintenance by the maintenance-and-recovery mechanism based on the set schedule.

In other words, the circuitry plans a maintenance schedule of the maintenance mechanism to perform an automatic maintenance when the liquid discharge apparatus is in standby mode based on the usage patterns, and controls the maintenance mechanism to perform the automatic maintenance according to the maintenance schedule.

### Aspect 3

In the liquid discharge apparatus according to Aspect 2, a frequency of the automatic maintenance is determined by using at least one of a drying speed, a sedimentation speed, or a discharge amount of the liquid discharged by the head or a temperature and humidity coefficient set based on temperature and humidity of a head environment.

In other words, the circuitry plans the maintenance schedule according to at least one of a drying speed of the liquid, a sedimentation speed, a discharge amount of the liquid discharged by the head, or a temperature and humidity coefficient based on an ambient temperature and humidity around the head.

### Aspect 4

In the liquid discharge apparatus according to any one of Aspects 1 to 3, the usage status learning unit learns days of the week and hours at which the user uses the liquid discharge apparatus, and the maintenance timing management unit determines the expected usage start time based on the usage status of the liquid discharge apparatus learned by the usage status learning unit.

In other words, the circuitry learns the usage patterns including used days of the week and used hours of the liquid discharge apparatus by the user.

### Aspect 5

In the liquid discharge apparatus according to any one of Aspects 1 to 4, the maintenance timing management unit optimizes the schedule of the automatic maintenance of the head in the liquid discharge apparatus during standby using the usage status of the liquid discharge apparatus learned by the usage status learning unit and at least one of a drying speed, a sedimentation speed, or a discharge amount of the liquid discharged by the head or a temperature and humidity coefficient set based on temperature and humidity of a head environment.

In other words, the circuitry reduces a frequency of the automatic maintenance of the head in the maintenance schedule according to the usage patterns and at least one of a drying speed of the liquid, a sedimentation speed, a discharge amount of the liquid discharged by the head, or a temperature and humidity coefficient based on an ambient temperature and humidity around the head.

### Aspect 6

The liquid discharge apparatus according to any one of Aspects 1 to 5, further includes multiple heads. The timing of maintenance for the multiple heads is determined for each of the heads.

In other words, the liquid discharge apparatus according to any one of Aspects 1 to 5, further includes multiple heads including the head. The circuitry plans the maintenance schedule for each of the multiple heads.

### Aspect 7

The liquid discharge apparatus according to any one of Aspects 1 to 6, further includes multiple heads. The timing of maintenance for the multiple heads is determined for each type of the liquid discharged by the heads.

In other words, the liquid discharge apparatus according to any one of Aspects 1 to 6, further includes multiple heads including the head. The circuitry plans the maintenance schedule for each of the multiple heads according to a type of the liquid discharged by each of the multiple heads.

### Aspect 8

A liquid discharge apparatus includes multiple heads to discharge a liquid, a maintenance-and-recovery mechanism to perform a maintenance of the heads, and a controller including a usage status learning unit and a maintenance timing management unit. A maintenance method for the liquid discharge apparatus includes a step in which the usage status learning unit learns a usage status of the liquid discharge apparatus by a user, a step in which the maintenance timing management unit determines an expected usage start time of the liquid discharge apparatus by the user based on the usage status of the liquid discharge apparatus learned by the usage status learning unit, a step in which the maintenance timing management unit sets a maintenance start time so that the maintenance is performed immediately before the expected usage start time, and a step in which the maintenance-and-recovery mechanism performs the maintenance of the heads at the set maintenance start time.

In other words, a maintenance method includes maintaining a head of a liquid discharge apparatus, learning usage patterns of a user to use the liquid discharge apparatus, determining an expected usage start time of the liquid discharge apparatus based on the usage patterns, setting a maintenance start time to start maintaining the head shortly before the expected usage start time, and starting maintaining the head at the maintenance start time and completing maintaining the head by the expected usage start time.

### Aspect 9

The maintenance method according to Aspect 8, further includes a step in which the maintenance timing management unit sets a schedule of an automatic maintenance for the head in the liquid discharge apparatus during standby based on the usage status of the liquid discharge apparatus learned by the usage status learning unit.

In other words, the maintenance method according to Aspect 8, further includes planning a maintenance schedule to perform an automatic maintenance when the liquid discharge apparatus is in standby mode based on the usage patterns and performing the automatic maintenance according to the maintenance schedule.

### Aspect 10

In the maintenance method according to Aspect 8 or 9, the maintenance timing management unit optimizes the schedule of the automatic maintenance for the head in the liquid discharge apparatus during standby using the usage status of the liquid discharge apparatus learned by the usage status learning unit and at least one of a drying speed, a sedimentation speed, or a discharge amount of the liquid discharged by the head or a temperature and humidity coefficient set based on temperature and humidity of a head environment.

In other words, the maintenance method according to claim 8 or 9, further includes reducing a frequency of the automatic maintenance of the head in the maintenance schedule according to the usage patterns and at least one of a drying speed of a liquid, a sedimentation speed, a discharge amount of the liquid discharged by the head, or a temperature and humidity coefficient based on an ambient temperature and humidity around the head.

### Aspect 11

In the liquid discharge apparatus according to any one of Aspects 1 to 7, the electrode is manufactured by forming an electrode material layer on an object.

As described above, according to one aspect of the present disclosure, a liquid discharge apparatus can be provided which optimizes the timing of maintenance based on the usage status and can obtain a desired printing quality from the start of printing.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

Any one of the above-described operations may be performed in various other ways, for example, in an order different from the one described above.

The functionality of the elements disclosed herein may be implemented using circuitry or processing circuitry which includes general purpose processors, special purpose processors, integrated circuits, ASICs (“Application Specific Integrated Circuits”), FPGAs (“Field-Programmable Gate Arrays”), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of a FPGA or ASIC.

1. A liquid discharge apparatus comprising:
a head to discharge a liquid;
a maintenance mechanism to maintain the head; and
circuitry configured to:
learn usage patterns of a user to use the liquid discharge apparatus;
determine an expected usage start time of the liquid discharge apparatus based on the usage patterns;
set a maintenance start time to start maintaining the head shortly before the expected usage start time; and
control the maintenance mechanism to:
start maintaining the head at the maintenance start time; and
complete maintaining the head by the expected usage start time.

2. The liquid discharge apparatus according to claim 1,
wherein the circuitry is further configured to:
plan a maintenance schedule of the maintenance mechanism to perform an automatic maintenance when the liquid discharge apparatus is in standby mode based on the usage patterns; and
control the maintenance mechanism to perform the automatic maintenance according to the maintenance schedule.

3. The liquid discharge apparatus according to claim 2,
wherein the circuitry is further configured to plan the maintenance schedule according to at least one of:
a drying speed of the liquid;
a sedimentation speed;
a discharge amount of the liquid discharged by the head; or
a temperature and humidity coefficient based on an ambient temperature and humidity around the head.

4. The liquid discharge apparatus according to claim 1,
wherein the circuitry is further configured to learn the usage patterns including used days of the week and used hours of the liquid discharge apparatus by the user.

5. The liquid discharge apparatus according to claim 2,
wherein the circuitry is further configured to reduce a frequency of the automatic maintenance of the head in the maintenance schedule according to:
the usage patterns; and
at least one of:
a drying speed of the liquid;
a sedimentation speed;
a discharge amount of the liquid discharged by the head; or
a temperature and humidity coefficient based on an ambient temperature and humidity around the head.

6. The liquid discharge apparatus according to claim 5, further comprising multiple heads including the head,
wherein the circuitry is further configured to plan the maintenance schedule for each of the multiple heads.

7. The liquid discharge apparatus according to claim 5, further comprising multiple heads including the head,
wherein the circuitry is further configured to plan the maintenance schedule for each of the multiple heads according to a type of the liquid discharged by each of the multiple heads.

8. A maintenance method comprising:
maintaining a head of a liquid discharge apparatus;
learning usage patterns of a user to use the liquid discharge apparatus;
determining an expected usage start time of the liquid discharge apparatus based on the usage patterns;
setting a maintenance start time to start maintaining the head shortly before the expected usage start time; and
starting maintaining the head at the maintenance start time; and
completing maintaining the head by the expected usage start time.

9. The maintenance method according to claim 8, further comprising:
planning a maintenance schedule to perform an automatic maintenance when the liquid discharge apparatus is in standby mode based on the usage patterns; and
performing the automatic maintenance according to the maintenance schedule.

10. The maintenance method according to claim 9, further comprising:
reducing a frequency of the automatic maintenance of the head in the maintenance schedule according to:
the usage patterns; and
at least one of:
a drying speed of a liquid;
a sedimentation speed;
a discharge amount of the liquid discharged by the head; or
a temperature and humidity coefficient based on an ambient temperature and humidity around the head.
